(19) United States
(12) Patent Application Publication
(10) Pub. No.: US 2026/0186638 A1
(43) Pub. Date: Jul. 2, 2026

(54) APPLICATION SWITCHING METHOD AND ELECTRONIC DEVICE

(71) Applicant: Lenovo (Beijing) Limited, Beijing (CN)

(72) Inventor: Binqiang MA, Beijing (CN)

(21) Appl. No.: 19/416,040

(22) Filed: Dec. 11, 2025

(30) Foreign Application Priority Data
Dec. 31, 2024 (CN) 202411999718.6

(51) Int. Cl. G06F 3/04842; G06F 3/04817

(52) U.S. Cl. CPC G06F 3/04842; G06F 3/04817; G06F 2203/04803

(57) ABSTRACT

An application switching method includes: presenting a display region including a first viewing region, the first viewing region being smaller than the display region, where the first viewing region includes a first sub-region and a second sub-region, the first sub-region being configured to display a display interface of an application, and the second sub-region being configured to display a label corresponding to the application; and in response to a target application being displayed in the first sub-region, displaying a target label corresponding to the target application in the second sub-region.

### CROSS-REFERENCE TO RELATED APPLICATION(S)

This application claims priority to Chinese Patent Application No. 202411999718.6 filed on Dec. 31, 2024, which is incorporated herein by reference in its entirety.

### FIELD OF THE TECHNOLOGY

The present disclosure relates to a field of computer processing technology, and in particular to an application switching method and an electronic device.

### BACKGROUND

With the development of internet technology, a wide variety of applications have been developed and used to meet people's daily needs. Consequently, electronic devices often display interfaces that run multiple applications simultaneously.

For example, while watching a movie on a mobile device, a user might want to switch between multiple chat applications on the screen. However, switching between multiple applications while using one application as a primary window is often cumbersome and time-consuming, impairing the user experience.

### SUMMARY

In one aspect, the present disclosure provides an application switching method. The method includes: presenting a display region including a first viewing region, the first viewing region being smaller than the display region, where the first viewing region includes a first sub-region and a second sub-region, the first sub-region being configured to display a display interface of an application, and the second sub-region being configured to display a label corresponding to the application; and in response to a target application being displayed in the first sub-region, displaying a target label corresponding to the target application in the second sub-region.

In another aspect, the present disclosure provides an electronic device. The device includes: a memory storing computer program instructions; and a processor coupled to the memory and configured to execute the computer program instructions and perform: presenting a display region including a first viewing region, the first viewing region being smaller than the display region, where the first viewing region includes a first sub-region and a second sub-region, the first sub-region being configured to display a display interface of an application, and the second sub-region being configured to display a label corresponding to the application; and in response to a target application being displayed in the first sub-region, displaying a target label corresponding to the target application in the second sub-region.

In yet another aspect, the present disclosure provides a non-transitory computer-readable storage medium storing computer program instructions executable by at least one processor to perform: presenting a display region including a first viewing region, the first viewing region being smaller than the display region, where the first viewing region includes a first sub-region and a second sub-region, the first sub-region being configured to display a display interface of an application, and the second sub-region being configured to display a label corresponding to the application; and in response to a target application being displayed in the first sub-region, displaying a target label corresponding to the target application in the second sub-region.

### BRIEF DESCRIPTION OF THE DRAWINGS

The objectives, features, and advantages of certain embodiments of the present disclosure become readily apparent upon reading the following detailed description with reference to the accompanying drawings. The accompanying drawings illustrate certain embodiments of the present disclosure by way of example and not limitation, where:
In the accompanying drawings, identical or corresponding reference numerals designate identical or corresponding parts.

FIG. 1 illustrates a schematic diagram of an implementation process of an application switching method according to certain embodiments of the present disclosure;

FIG. 2 illustrates an exemplary display region according to certain embodiments of the present disclosure;

FIG. 3 illustrates an exemplary display region according to certain embodiments of the present disclosure;

FIG. 4 illustrates an exemplary display region according to certain embodiments of the present disclosure; and

FIG. 5 illustrates a schematic diagram of a structure of an electronic device according to certain embodiments of the present disclosure.

### DETAILED DESCRIPTION

To make the objectives, features, and advantages of the present disclosure more apparent and understandable, the following describes the technical solutions in certain embodiments of the present disclosure, in conjunction with the accompanying drawings. The embodiments described represent certain embodiments of the present disclosure, and not all of the embodiments. Other embodiments obtained by those skilled in the technical field based on certain embodiments of the present disclosure without inventive effort are in the scope of protection of the present disclosure.

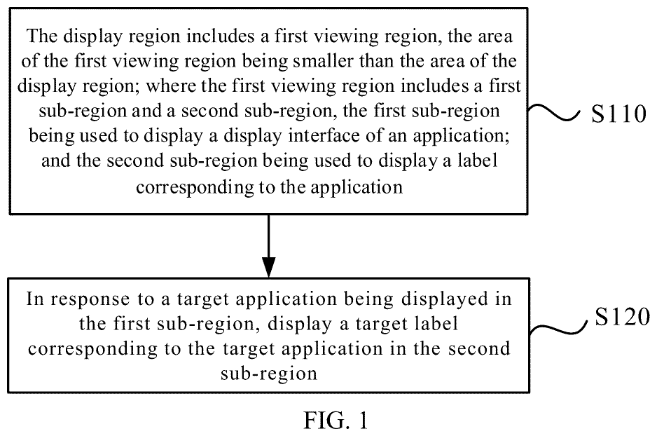

FIG. 1 is a flowchart of an application switching method provided in certain embodiments of the present disclosure. This method may be performed by an application switching device provided in certain embodiments of the present disclosure, which may be implemented using software and/or hardware. In certain embodiments, the method includes:
S110. The display region includes a first viewing region, the area of the first viewing region being smaller than the area of the display region; where the first viewing region includes a first sub-region and a second sub-region, the first sub-region being used to display a display interface of an application, and the second sub-region being used to display a label corresponding to the application.

In certain embodiments, the display region of the electronic device's display screen may be divided into two parts, including a first viewing region and a second viewing region. The first viewing region is smaller than the display region of the display screen and is used to facilitate user switching between multiple applications. The second viewing region is used to display the application that the user wants to maximize viewing. To facilitate user switching and operation of different applications in the first viewing region, in certain embodiments, the first viewing region may be divided into the first sub-region and the second sub-region, with the first sub-region displaying the application interface and the second sub-region displaying the label corresponding to the application.

Because the first viewing region facilitates access to other applications while the user is using the primary application, it does not occupy the entire interface of the display region. For example, in certain embodiments, the display area of the first viewing region may be set to ½ of the display region or ⅓ of the display region, or may be customized based on user needs. Certain embodiments do not limit the display area of the first viewing region. Furthermore, certain embodiments do not limit the display location of the first viewing region; it may be set anywhere.
S120. In response to a target application being displayed in the first sub-region, display a target label corresponding to the target application in the second sub-region.

The target application is the application displayed in the first sub-region, and the target label is the label corresponding to the target application.

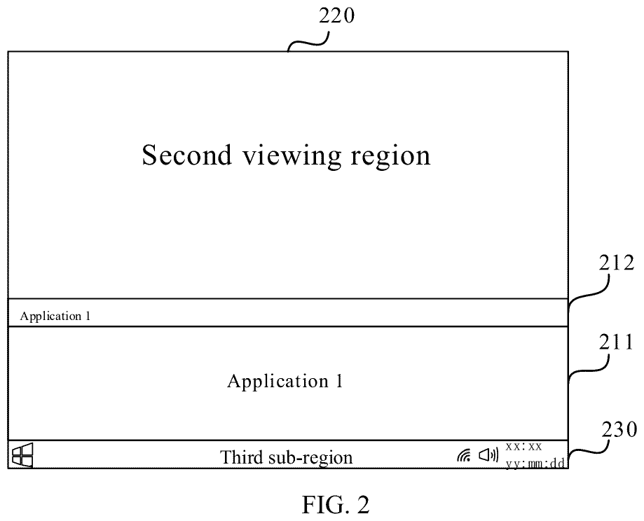

FIG. 2 is an illustrative diagram of an exemplary display region provided in certain embodiments of the present disclosure. As shown in FIG. 2, the display region includes a first viewing region which in turn includes a first sub-region 211 and a second sub-region 212, as well as a second viewing region 220 and a third sub-region 230. Certain embodiments illustrate an exemplary display method for displaying application 1 in the first viewing region, including displaying the running interface of application 1 in first sub-region 211 and displaying the label of application 1 in the second sub-region 212.

The third sub-region 230 may be a taskbar in the display region, which is used to display menus in the electronic device system, icons of fixed frequently used applications, icons of currently running applications, and icons of system time, sound, or the like. Certain embodiments conform to the user's common usage habits and set the first viewing region to a lower location of the display region for user convenience.

Certain embodiments include a first viewing region in the display region, the first viewing region being smaller than the display region. The first viewing region includes a first sub-region and a second sub-region. The first sub-region is used to display the application interface; the second sub-region is used to display the label corresponding to the application. In response to a target application being displayed in the first sub-region, a target label corresponding to the target application is displayed in the second sub-region. This may resolve the issues of display clutter and cumbersome switching when multiple applications are executed simultaneously on the display interface, thereby improving the user experience.

In certain embodiments, the method includes: in response to a target application being displayed in the first sub-region, the target label corresponding to the target application and being in the second sub-region is at a target display state, and the label corresponding to non-target application and being in the second sub-region is at a non-target display state.

The target display state may include elongating the target label and/or displaying a different color.

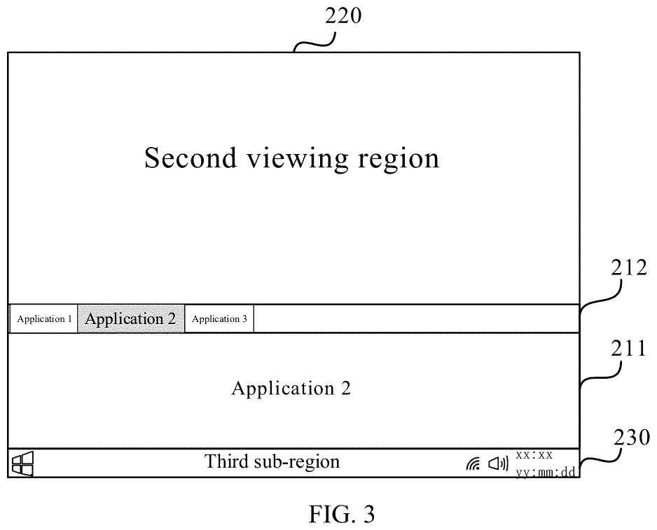

Certain embodiments relate to scenarios involving application switching in the first viewing region. For example, certain embodiments may set a default, fixed label in the second sub-region. This label may be customized based on user needs. Even when other target applications are opened in the second sub-region, this label remains displayed in the second sub-region. For another example, certain embodiments may open multiple target applications in the first sub-region, with the target application currently being used displayed over the other target applications. When the user needs to use another target application, the user may switch applications using the label in the second sub-region, as shown in FIG. 3.

FIG. 3 is an illustrative diagram of a display region provided by certain embodiments of the present disclosure. As shown in FIG. 3, a user has opened three target applications in the first viewing region: Application 1, Application 2, and Application 3. Certain embodiments display Application 2, which the user is currently using, in the first sub-region. Its corresponding target label appears elongated and gray in the second sub-region, while the labels corresponding to Applications 1 and 3 are at a non-target display state.

Certain embodiments distinguish the target applications currently being used by the user in the first sub-region by setting target and non-target display states, making them easier for the user to view.

In certain embodiments of the present disclosure, the method includes: in response to input information regarding a first target label in the second sub-region, displaying a first target application corresponding to the first target label in the first sub-region, where the first target label is at a target display state in the second sub-region.

The input information may be a user operation to open the first target application, such as a click, double-click, opening a menu bar, or dragging.

In certain embodiments, all target labels in the second sub-region are displayed, differing only in whether they are at the target display state. When a user wishes to use the first target application, the user may open the first target label in the second sub-region. This causes the first target application to be displayed in the first sub-region, and the first target label to be changed from a non-target display state to a target display state.

In certain embodiments, the display region includes a second viewing region, which is a region of the display region other than the first viewing region. The second viewing region has a third sub-region. The method includes at least one of:
in response to the first sub-region displaying a second target application, a second target icon corresponding to the second target application is displayed in the third sub-region;
in response to the first sub-region displaying a second target application, the second target icon corresponding to the second target application is not displayed in the third sub-region;
in response to the second target application being displayed in the first sub-region, obtaining the minimum display size of the second target application and, based on the relationship between the minimum display size and the size of the first viewing region, determining whether to display the second target icon corresponding to the second target application in the third sub-region; or,
in response to the second target application being displayed in the first sub-region, determining whether the second target application may be minimized, thereby determining whether to display the second target icon corresponding to the second target application in the third sub-region; or
in response to the first sub-region displaying a second target application, a determination is made as to whether the second target application is on a display restriction list, thereby determining whether to display a second target icon corresponding to the second target application in the third sub-region. The display restriction list includes at least one application name whose icon is not displayed in the third sub-region.

The area of the third sub-region is smaller than the second viewing region, and the sum of the areas of the second viewing region and the first viewing region aligns with the displayable area of the display screen. Furthermore, the second, first, and third sub-regions are arranged sequentially along the screen display direction, and the three regions are connected, as shown in FIGS. 2 and 3.

In certain embodiments, when a user opens an application on an electronic device, the corresponding icon is displayed in the display bar to facilitate user operation. In certain embodiments, after the display region is provided with a first viewing region, when the user wishes to display a second target application in the first sub-region, not only may the target label corresponding to the second target application be displayed in the second sub-region, but the label in the third sub-region may also be retained, that is, the second target icon corresponding to the second target application may be displayed in the third sub-region. Alternatively, in order to simplify the display region, certain embodiments may simply display the target label corresponding to the second target application in the second sub-region, eliminating the need for redundant display. Therefore, the second target icon corresponding to the second target application may be omitted from the third sub-region.

In certain embodiments, the minimum display size of the second target application may be obtained and compared with the size of the first viewing region. When the minimum display size is larger than the first viewing region, the second target icon may be omitted from the third sub-region. When the minimum display size is smaller than the first viewing region, the second target icon may be displayed in the third sub-region.

In certain embodiments, a display restriction list may be obtained and, by iterating through the application names in the display restriction list, when the second target application is included in the display restriction list, the second target icon may be omitted from the third sub-region. The display restriction list is similar to a blacklist and may record the names of applications whose labels are not displayed in the third sub-region for various reasons.

Certain embodiments may display the label or icon corresponding to the second target application in the second sub-region and the third sub-region at the same time, giving the user multiple paths to operate the second target application; in order to avoid operation conflicts, when it is determined that the second target application is displayed in the first sub-region, only the second target label is displayed in the second sub-region, and the second target icon is not displayed in the third sub-region.

In certain embodiments of the present disclosure, determining whether to display the second target icon corresponding to the second target application in the third sub-region based on the relationship between the minimum display size and the size of the first viewing region includes: in response to the minimum display size of the second target application being larger than the size of the first viewing region, not displaying the second target icon corresponding to the second target application in the third sub-region; and displaying a progress bar in the first viewing region, the progress bar being used to adjust the content displayed by the second target application in the first sub-region; or, modifying the minimum display size of the second target application based on the display resolution of the first viewing region; or, modifying the display resolution of the first viewing region based on the minimum display size of the second target application.

The size mentioned in certain embodiments may refer to the size in the display direction, for example, the height.

Certain embodiments may compare the minimum display size of the second target application with the size of the first viewing region. When the minimum display size of the second target application is larger than the size of the first viewing region, the second target icon is not displayed in the third sub-region.

Certain embodiments may include a progress bar in the first viewing region, which may be used to adjust the content displayed by the second target application in the first sub-region. Alternatively, because the display resolution of the second target application adaptively adjusts its display size based on the resolution of the electronic device's display screen, certain embodiments may obtain the display resolution of the first viewing region and send it to the backend of the second target application. This allows the second target application to adaptively adjust to the new minimum display size based on the display resolution of the first viewing region. Alternatively, certain embodiments may obtain the minimum display size of the second target application and modify the display resolution of the first viewing region based on the minimum display size of the second target application, thereby adapting the size of the first viewing region to the minimum display size of the second target application.

Certain embodiments address scenarios where the minimum display size of the second target application is larger than the display resolution of the first viewing region, and provide various solutions to accommodate the varying needs of different users or display screen characteristics.

In certain embodiments, the method includes: in response to the second sub-region displaying multiple third labels respectively corresponding to multiple third target applications, displaying third target icon corresponding to each third target application in the third sub-region, or not displaying the third target icon corresponding to each third target application in the third sub-region; or

In response to the second sub-region displaying multiple third labels respectively corresponding to multiple third target applications, a determination is made as to whether to display the third target icon corresponding to each third target application in the third sub-region based on application information of each third target application.

The application information may include, for example, the minimum display size of the third target application and whether the application is in a display restriction list.

In certain embodiments, multiple third target applications are open in the first viewing region. The second sub-region will display third labels respectively corresponding to each of the third target applications. Certain embodiments may maintain consistency between the second and third sub-regions, while also displaying multiple third target icons corresponding to each of the third target applications in the third sub-region for the user to select. Alternatively, since the third label is already displayed in the second sub-region for the user to use, the third target icons corresponding to all third target applications may be omitted in the third sub-region to simplify the interface. Alternatively, certain embodiments may determine whether to display the third target icons in the third sub-region based on the unique application information of each third target application.

Certain embodiments involve determining whether to uniformly display the corresponding third target icons in the third sub-region when multiple third target applications are open. Certain embodiments may maintain a consistent display of all third target applications in the third sub-region, or completely omit the display. Alternatively, it may be configured to vary the display based on the characteristics of each application, providing diverse implementation options to meet the needs of different users or electronic devices.

In certain embodiments, the method includes:
in response to a user selecting a fourth target icon in the third sub-region, a fourth target application corresponding to the fourth target icon is displayed in the first sub-region, and a fourth label corresponding to the fourth target application is simultaneously displayed in the second sub-region at a target display state; and
in response to a user selecting a fourth target label in the second sub-region, a fourth target icon corresponding to the fourth target application is simultaneously displayed in the third sub-region at a target display state.

Certain embodiments may maintain consistency between the fourth target icon and the fourth target label. When a user selects the fourth target icon in the third sub-region, in addition to opening the fourth target application, the fourth label may be simultaneously displayed in the second sub-region as being at the target display state. Furthermore, when a user selects the fourth target label in the second sub-region, the fourth target icon may also be simultaneously displayed as being at the target display state.

Certain embodiments involve determining whether the fourth target label makes a consistent response by changing to the target display state when the fourth target icon is selected, and whether the fourth target icon makes a consistent response by changing to the target display state when the fourth target label is selected. Certain embodiments recommend maintaining consistency between the display of the fourth target label and the fourth target icon to indicate that the fourth target application is displayed as running in the first sub-region.

In certain embodiments of the present disclosure, the method includes: in response to the display region being of a first display size, maintaining a fixed display area for the first viewing region; and in response to the display region being of a second display size, enabling the display area of the first viewing region to be switchable between multiple display areas.

The first display size may be an electronic device display screen with the size of its display region not changeable; the second display size may be a variable size of an electronic device display screen, a size after the display region is enlarged, such as the display size of a scrollable or foldable screen electronic device.

In certain embodiments, the display area of the first viewing region may be changed according to the display size of the display region. For example, when the current display region of the display screen is of the first display size, the display area of the first viewing region may be set to be fixed and cannot be changed. When the current display region of the display screen is of the second, enlarged display size, since the display region is large enough, certain embodiments may adaptively increase the first viewing region, that is, it may switch between multiple display areas.

For electronic devices with variable display screens, after the display screen's display region reaches the enlarged second display size, certain embodiments may set the first viewing region to the desired display area based on user settings, or automatically change to the larger display area based on monitoring to accommodate the enlarged display size.

For example, for the first display size, certain embodiments may set the display area of the first viewing region to ⅓ of the display screen's display region; for the second display size, certain embodiments may set the display area of the first viewing region to ½ or ⅓ of the display screen's display region, or may customize the area based on user needs.

In certain embodiments, when the display region is of the first display size, the excessive display area of the first viewing region affects the display area of the second viewing region. Therefore, certain embodiments may set the display area of the first viewing region to a fixed display area, that is, it has only two modes: display or non-display, and the size of the first viewing region is fixed when displayed. When the display region is of the second display size, the display area of the display screen increases, leaving sufficient space for the second viewing region. Therefore, certain embodiments may set the display area of the first viewing region to be a variable display area, that is, in addition to the normal display or non-display mode, it may also have multiple display sizes.

Certain embodiments configure the first viewing region to have multiple display sizes, adapting to the screen displays of various electronic devices. Certain embodiments feature a solution for adaptively adjusting the display size for variable screen sizes, providing wide applicability and improving user experience.

In certain embodiments, after establishing a target label corresponding to the target application in the second sub-region, the following steps are included: displaying the target application in the entire area of the first sub-region; or, providing multiple display windows in the first sub-region, displaying the target application in one of the display windows.

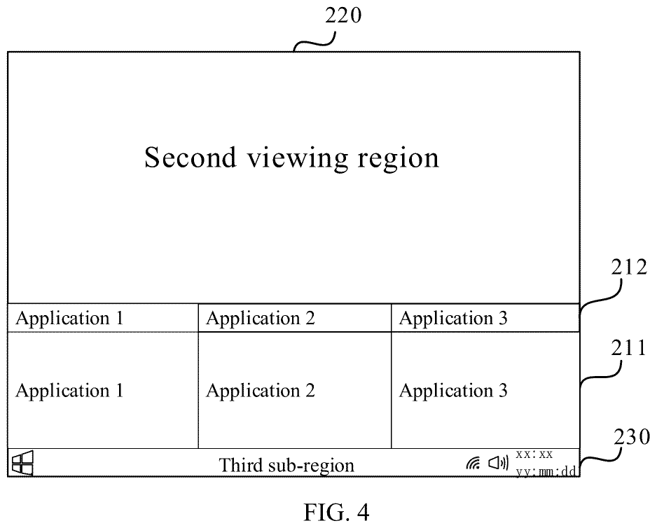

Certain embodiments may display the target application in the entire first sub-region, as shown in FIGS. 2 and 3. Multiple display windows may be set in the first sub-region, and the target application may be displayed in one of the display windows in the first sub-region, as shown in FIG. 4.

Certain embodiments provide multiple display windows in the first sub-region to facilitate users viewing and use multiple target applications simultaneously.

In certain embodiments of the present disclosure, before displaying the target application in the first sub-region, the process includes: responding to the target application's display interface entering the first sub-region with an area exceeding a first preset area; or responding to the target application's display interface entering a first preset location in the first sub-region; or responding to the target application's display icon entering the first sub-region with an area exceeding a second preset area; or responding to the target application's display icon entering a second preset location in the first sub-region; or responding to a user opening the target application.

The first preset area may be, for example, half the area of the target application's display interface, and the first preset location may be, for example, the center of the first sub-region. The second preset area may be, for example, half the area of the target application's display icon, and the second preset location may be, for example, any location in the first sub-region. Certain embodiments do not limit the particular preset areas and preset locations.

Certain embodiments relate to trigger operations for opening a target application in the first sub-region. For example, when the target application is already open and area of its display interface which enters the first sub-region exceeds half of the target application's display interface area, the target application will be opened in the first sub-region. Alternatively, when the target application is already open and its display interface reaches the center of the first sub-region, the target application will be opened in the first sub-region. Alternatively, when the target application is not open and area of its display icon which enters the first sub-region exceeds half of the target application's display icon area, the target application will be opened in the first sub-region. Alternatively, when the target application is not open and its display icon reaches any location in the first sub-region, the target application will be opened in the first sub-region. Alternatively, the user may right-click to open the menu bar and select a display method to open the target application.

Certain embodiments involve various trigger scenarios for opening a target application in the first sub-region, including commonly used methods such as dragging, sliding, or opening a menu item, thereby providing diverse ways to open the target application in the first sub-region.

Certain embodiments include:
in response to a user maximizing a fifth target application, displaying the fifth target application in the entire second viewing region, or displaying the fifth target application in the entire display region; and/or
in response to a user closing operation on a sixth target application, the sixth target application is closed and the sixth target label corresponding to the sixth target application is removed from the second sub-region; or, in response to a user closing operation on the sixth target application, the sixth target application is closed and the sixth target label corresponding to the sixth target application is retained in the second sub-region; and/or,
in response to a user closing operation on a seventh target label, the seventh target label is removed from the second sub-region and the seventh target application corresponding to the seventh target label is moved out of the first sub-region to the second viewing region; and/or,
in response to the user moving the eighth target application out of the first sub-region, or moving the eighth target label corresponding to the eighth target application out of the second sub-region, the eighth target application is displayed in the second viewing region.

Certain embodiments relate to a scenario in which the user maximizes the fifth target application in the first sub-region. When the user maximizes the fifth target application, certain embodiments may display only the fifth target application in the entire second viewing region, or may display the fifth target application in the entire display region.

Certain embodiments relate to a scenario in which a user directly closes a sixth target application in the first sub-region. When the user closes the sixth target application, certain embodiments close the sixth target application in the first sub-region and remove the sixth target label corresponding to the sixth target application in the second sub-region. Alternatively, after closing the sixth target application, the sixth target label is retained in the second sub-region to facilitate reopening by the user.

Certain embodiments relate to a scenario in which a user directly closes a seventh target label in the second sub-region. When the user closes the seventh target label, certain embodiments not only remove the seventh target label from the second sub-region but also moves the seventh target application out of the first sub-region to the second viewing region. In other words, the seventh target application is restored to its original display in the second viewing region and is not closed.

Certain embodiments involve a scenario in which a user moves an eighth target application out of the first sub-region. When the user moves the eighth target application out of the first sub-region, or moves the eighth target label corresponding to the eighth target application out of the second sub-region, the eighth target application is restored to its original display in the second viewing region.

Certain embodiments cover various common use scenarios for displaying a target application in the first viewing region and provide solutions for closing, moving, or restoring the target application to its original display, thereby improving the user experience.

In certain embodiments of the present disclosure, the method includes: in response to a user maximizing an application in the second viewing region, displaying the application in the second viewing region in its entirety.

Certain embodiments relate to a scenario in which a user maximizes other commonly used applications in the second viewing region. When a user maximizes an application in the second viewing region, certain embodiments may display the application in its entirety, rather than the entire display region, of the display screen. This avoids masking the first viewing region, facilitating normal user access to the application in the first viewing region.

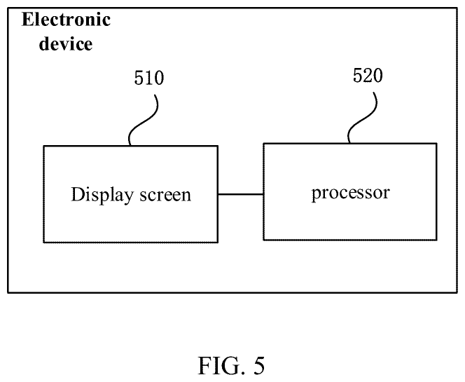

FIG. 5 is a schematic diagram of a structure of an electronic device provided by certain embodiments of the present disclosure. The device includes: a display screen 510 and a processor 520.

The display screen 510 is configured to have a first viewing region in a display region. The first viewing region is smaller than the display region. The first viewing region includes a first sub-region and a second sub-region. The first sub-region is configured to display an application interface; the second sub-region is configured to display a label for each application.

The processor 520 is configured to, in response to the first sub-region displaying a target application, establish a target label corresponding to the target application in the second sub-region; and, in response to the first sub-region displaying a target application, configure the target label corresponding to the target application in the second sub-region to be at a target display state, and configure the labels of non-target applications in the second sub-region to be at a non-target display state.

In certain embodiments, the display region of the display screen 510 includes a first display size and a second display size. The processor 520 is configured to, in response to the display region being in the first display size, configure the display region of the first viewing region to be a fixed display area; and, in response to the display region being in the second display size, configure the display region of the first viewing region to be switchable between multiple display areas.

In certain embodiments, the processor 520 includes:
in response to the first sub-region displaying a target application, the target label corresponding to the target application in the second sub-region is at a target display state, and the label corresponding to non-target applications in the second sub-region is at a non-target display state.

In certain embodiments, the processor 520 includes:
in response to input information regarding a first target label in the second sub-region, a first target application corresponding to the first target label is displayed in the first sub-region, where the first target label is at a target display state in the second sub-region.

In certain embodiments, the display region includes a second viewing region, which is a region of the display region other than the first viewing region, and has a third sub-region. The processor 520 includes at least one of:
in response to the first sub-region displaying a second target application, a second target icon corresponding to the second target application is displayed in the third sub-region;
in response to the first sub-region displaying a second target application, the second target icon corresponding to the second target application is not displayed in the third sub-region;
in response to the second target application being displayed in the first sub-region, obtaining the minimum display size of the second target application and, based on the relationship between the minimum display size and the size of the first viewing region, determining whether to display the second target icon corresponding to the second target application in the third sub-region; or,
in response to the second target application being displayed in the first sub-region, determining whether the second target application may be minimized, thereby determining whether to display the second target icon corresponding to the second target application in the third sub-region; or
in response to the first sub-region displaying a second target application, determining whether the second target application is on a display restriction list to determine whether to display a second target icon corresponding to the second target application in the third sub-region, where the display restriction list includes at least one application name, the icon of which is not displayed in the third sub-region.

In certain embodiments, the processor 520 includes:
in response to the minimum display size of the second target application being larger than the size of the first viewing region, not displaying the second target icon corresponding to the second target application in the third sub-region; and
displaying a progress bar in the first viewing region, the progress bar being used to adjust the content displayed by the second target application in the first sub-region; or, modifying the minimum display size of the second target application based on the display resolution of the first viewing region; or, modifying the display resolution of the first viewing region based on the minimum display size of the second target application.

In certain embodiments, the processor 520 includes:
in response to the second sub-region displaying a plurality of third labels corresponding to a plurality of third target applications, displaying a third target icon corresponding to each of the third target applications in the third sub-region, or not displaying the third target icon corresponding to each of the third target applications in the third sub-region; or
in response to the second sub-region displaying multiple third labels respectively corresponding to multiple third target applications, determining whether to display the third target icon corresponding to each third target application in the third sub-region based on application information of each third target application.

In certain embodiments, the processor 520 includes:
in response to a user selecting a fourth target icon in the third sub-region, a fourth target application corresponding to the fourth target icon is displayed in the first sub-region, and a fourth label corresponding to the fourth target application is simultaneously displayed in the second sub-region in a target display state; and,
in response to a user selecting a fourth target label in the second sub-region, a fourth target icon corresponding to the fourth target application is simultaneously displayed in the third sub-region at a target display state.

In certain embodiments, the processor 520 includes:
in response to the display region being of a first display size, the display area of the first viewing region is a fixed display area;
in response to the display region being of a second display size, the display area of the first viewing region is switchable among a plurality of display areas.

In certain embodiments, the processor 520 includes: after establishing a target label corresponding to the target application in the second sub-region, displaying the target application in the entire area of the first sub-region; or, setting multiple display windows in the first sub-region, displaying the target application in one of the display windows.

In certain embodiments, the processor 520 includes: before displaying the target application in the first sub-region, in response to an area of the target application's display interface which enters the first sub-region exceeds a first preset area; or in response to the target application's display interface reaching a first preset location in the first sub-region; or in response to an area of the target application's display icon which enters the first sub-region exceeds a second preset area; or in response to the target application's display icon reaching a second preset location in the first sub-region; or in response to a user opening the target application.

In certain embodiments, the processor 520 includes:
in response to the user maximizing the fifth target application, displaying the fifth target application in the entire second viewing region, or displaying the fifth target application in the entire display region; and/or
in response to a user closing operation on a sixth target application, the sixth target application is closed and the sixth target label corresponding to the sixth target application is removed from the second sub-region; or, in response to a user closing operation on the sixth target application, the sixth target application is closed and the sixth target label corresponding to the sixth target application is retained in the second sub-region; and/or,
in response to a user closing operation on a seventh target label, the seventh target label is removed from the second sub-region and the seventh target application corresponding to the seventh target label is moved out of the first sub-region to the second viewing region; and/or,
in response to the user moving the eighth target application out of the first sub-region, or moving the eighth target label corresponding to the eighth target application out of the second sub-region, displaying the eighth target application in the second viewing region.

In certain embodiments, the processor 520 includes: in response to the user maximizing the application in the second viewing region, displaying the application in the second viewing region in the entire second viewing region.

Various forms of the processes shown above may be used, with steps reordered, added, or deleted. For example, the steps described in the present disclosure may be performed in parallel, sequentially, or in a different order, as long as the desired results of the technical solutions disclosed herein are achieved. The present disclosure does not impose limitations on order or number of the steps.

Furthermore, the terms “first” and “second” are used for descriptive purposes only and are not construed to indicate or imply relative importance or implicitly indicate the number of technical features. Thus, features described as “first” or “second” may explicitly or implicitly include at least one such feature. In the description of the present disclosure, “plurality” means two or more, unless otherwise defined.

The description reflects certain embodiments of the present disclosure, but the scope of protection of the present disclosure is not limited to the embodiments as described. Any changes or substitutions that may be readily obtained by a person skilled in the technical field in the technical scope disclosed in the present disclosure should be included in the scope of protection of the present disclosure. Therefore, the scope of protection of the present disclosure is based on the scope of protection of the claims.

What is claimed is:

1. An application switching method, comprising:
presenting a display region including a first viewing region, the first viewing region being smaller than the display region, wherein the first viewing region includes a first sub-region and a second sub-region, the first sub-region being configured to display a display interface of an application, and the second sub-region being configured to display a label corresponding to the application; and
in response to a target application being displayed in the first sub-region, displaying a target label corresponding to the target application in the second sub-region.

2. The method of claim 1, further comprising:
in response to the target application being displayed in the first sub-region, placing the target label corresponding to the target application in the second sub-region at a target display state, and placing labels corresponding to non-target applications in the second sub-region at a non-target display state.

3. The method of claim 2, further comprising:
in response to input information regarding a first target label in the second sub-region, causing a first target application corresponding to the first target label to be displayed in the first sub-region, wherein the first target label is at a target display state in the second sub-region.

4. The method of claim 1, wherein the display region includes a second viewing region, the second viewing region being a region of the display region other than the first viewing region, the second viewing region having a third sub-region, and the method comprising at least one of:
in response to a second target application being displayed in the first sub-region, displaying a second target icon corresponding to the second target application in the third sub-region;
in response to the second target application being displayed in the first sub-region, not displaying the second target icon corresponding to the second target application in the third sub-region;
in response to the second target application being displayed in the first sub-region, obtaining a minimum display size of the second target application and, based on a relationship between the minimum display size and a size of the first viewing region, determining whether to display the second target icon corresponding to the second target application in the third sub-region; or,
in response to the second target application being displayed in the first sub-region, determining whether the second target application may be minimized, thereby determining whether to display the second target icon corresponding to the second target application in the third sub-region; or,
in response to the second target application being displayed in the first sub-region, determining whether the second target application is on a display restriction list, thereby determining whether to display the second target icon corresponding to the second target application in the third sub-region, wherein the display restriction list includes at least one application name whose icon is not displayed in the third sub-region.

5. The method of claim 4, wherein determining whether to display the second target icon corresponding to the second target application in the third sub-region based on the relationship between the minimum display size and the size of the first viewing region includes:
in response to the minimum display size of the second target application being larger than the size of the first viewing region, not displaying the second target icon corresponding to the second target application in the third sub-region; and
displaying a progress bar in the first viewing region, the progress bar being configured to adjust a content displayed by the second target application in the first sub-region; or, modifying the minimum display size of the second target application based on a display resolution of the first viewing region; or, modifying the display resolution of the first viewing region based on the minimum display size of the second target application.

6. The method of claim further comprising:
in response to the second sub-region displaying multiple third labels corresponding to multiple third target applications, displaying third target icon corresponding to each third target application in the third sub-region, or not displaying the third target icon corresponding to each third target application in the third sub-region; or
in response to the second sub-region displaying multiple third labels corresponding to multiple third target applications, determining whether to display the third target icon corresponding to each third target application in the third sub-region based on application information of each third target application.

7. The method of claim 4, further comprising:
in response to a user selecting a fourth target icon in the third sub-region, displaying a fourth target application corresponding to the fourth target icon in the first sub-region, and simultaneously displaying a fourth label corresponding to the fourth target application in the second sub-region at a target display state; and
in response to a user selecting the fourth target label in the second sub-region, simultaneously displaying a fourth target icon corresponding to the fourth target application in the third sub-region at a target display state.

8. The method of claim 1, further comprising:
in response to the display region being of a first display size, configuring a display area of the first viewing region as a fixed display area; and
in response to the display region being of a second display size, configuring the display area of the first viewing region as switchable between multiple display areas.

9. The method of claim 1, after establishing the target label corresponding to the target application in the second sub-region, further comprising:
displaying the target application in an entire area of the first sub-region; or
setting multiple display windows in the first sub-region, displaying the target application in one of the display windows.

10. The method of claim 1, wherein, before displaying the target application in the first sub-region, the method further comprises at least one of:
in response to an area of the target application's display interface entering the first sub-region exceeding a first preset area;
in response to the target application's display interface reaching a first preset location in the first sub-region;
in response to an area of the target application's display icon entering the first sub-region exceeding a second preset area;
in response to the target application's display icon reaching a second preset location in the first sub-region; and
in response to a user opening the target application.

11. The method of claim 4, further comprising:
in response to a user maximizing a fifth target application, displaying the fifth target application in the entire second viewing region, or displaying the fifth target application in the entire display region; and/or
in response to a user closing a sixth target application, closing the sixth target application and removing a sixth target label corresponding to the sixth target application from the second sub-region; or, in response to a user closing the sixth target application, closing the sixth target application and retaining the sixth target label corresponding to the sixth target application in the second sub-region; and/or
in response to a user closing a seventh target label, removing the seventh target label from the second sub-region and moving the seventh target application corresponding to the seventh target label out of the first sub-region to the second viewing region; and/or
in response to a user moving an eighth target application out of the first sub-region, or moving the eighth target label corresponding to the eighth target application out of the second sub-region, displaying the eighth target application in the second viewing region.

12. An electronic device, comprising: a memory storing computer program instructions; and
a processor coupled to the memory and configured to execute the computer program instructions and perform:
presenting a display region including a first viewing region, the first viewing region being smaller than the display region, wherein the first viewing region includes a first sub-region and a second sub-region, the first sub-region being configured to display a display interface of an application, and the second sub-region being configured to display a label corresponding to the application; and
in response to a target application being displayed in the first sub-region, displaying a target label corresponding to the target application in the second sub-region.

13. The electronic device of claim 12, wherein the processor is further configured to perform:
in response to the target application being displayed in the first sub-region, placing the target label corresponding to the target application in the second sub-region at a target display state, and placing labels corresponding to non-target applications in the second sub-region at a non-target display state.

14. The electronic device of claim 13, wherein the processor is further configured to perform:
in response to input information regarding a first target label in the second sub-region, causing a first target application corresponding to the first target label to be displayed in the first sub-region, wherein the first target label is at a target display state in the second sub-region.

15. The electronic device of claim 12, wherein the display region includes a second viewing region, the second viewing region being a region of the display region other than the first viewing region, the second viewing region having a third sub-region, and the method comprising at least one of:
in response to a second target application being displayed in the first sub-region, displaying a second target icon corresponding to the second target application in the third sub-region;
in response to the second target application being displayed in the first sub-region, not displaying the second target icon corresponding to the second target application in the third sub-region;
in response to the second target application being displayed in the first sub-region, obtaining a minimum display size of the second target application and, based on a relationship between the minimum display size and a size of the first viewing region, determining whether to display the second target icon corresponding to the second target application in the third sub-region; or,
in response to the second target application being displayed in the first sub-region, determining whether the second target application may be minimized, thereby determining whether to display the second target icon corresponding to the second target application in the third sub-region; or,
in response to the second target application being displayed in the first sub-region, determining whether the second target application is on a display restriction list, thereby determining whether to display the second target icon corresponding to the second target application in the third sub-region, wherein the display restriction list includes at least one application name whose icon is not displayed in the third sub-region.

16. The electronic device of claim 15, wherein determining whether to display the second target icon corresponding to the second target application in the third sub-region based on the relationship between the minimum display size and the size of the first viewing region includes:
in response to the minimum display size of the second target application being larger than the size of the first viewing region, not displaying the second target icon corresponding to the second target application in the third sub-region; and
displaying a progress bar in the first viewing region, the progress bar being configured to adjust a content displayed by the second target application in the first sub-region; or, modifying the minimum display size of the second target application based on a display resolution of the first viewing region; or, modifying the display resolution of the first viewing region based on the minimum display size of the second target application.

17. The electronic device of claim 15, wherein the processor is further configured to perform:
in response to the second sub-region displaying multiple third labels corresponding to multiple third target applications, displaying third target icon corresponding to each third target application in the third sub-region, or not displaying the third target icon corresponding to each third target application in the third sub-region; or
in response to the second sub-region displaying multiple third labels corresponding to multiple third target applications, determining whether to display the third target icon corresponding to each third target application in the third sub-region based on application information of each third target application.

18. The electronic device of claim 15, wherein the processor is further configured to perform:
in response to a user selecting a fourth target icon in the third sub-region, displaying a fourth target application corresponding to the fourth target icon in the first sub-region, and simultaneously displaying a fourth label corresponding to the fourth target application in the second sub-region at a target display state; and
in response to a user selecting the fourth target label in the second sub-region, simultaneously displaying a fourth target icon corresponding to the fourth target application in the third sub-region at a target display state.

19. The electronic device of claim 12, wherein the processor is further configured to perform:
in response to the display region being of a first display size, configuring a display area of the first viewing region as a fixed display area; and
in response to the display region being of a second display size, configuring the display area of the first viewing region as switchable between multiple display areas.

20. A non-transitory computer-readable storage medium storing computer program instructions executable by at least one processor to perform:
presenting a display region including a first viewing region, the first viewing region being smaller than the display region, wherein the first viewing region includes a first sub-region and a second sub-region, the first sub-region being configured to display a display interface of an application, and the second sub-region being configured to display a label corresponding to the application; and
in response to a target application being displayed in the first sub-region, displaying a target label corresponding to the target application in the second sub-region.
